(19) United States
(12) Patent Application Publication
(10) Pub. No.: US 2015/0125720 A1
(43) Pub. Date: May 7, 2015

(54) POWER SOURCE DEVICE, ELECTRIC VEHICLE PROVIDED WITH SAME, AND ELECTRICITY STORAGE DEVICE

(71) Applicant: SANYO Electric Co., Ltd., Osaka (JP)

(72) Inventors: Kazuhiro Fujii, Hyogo (JP); Tetsuji Omura, Hyogo (JP)

(21) Appl. No.: 14/400,552

(22) PCT Filed: Aug. 1, 2013
(86) PCT No.: PCT/JP2013/004658

§ 371 Date: Nov. 12, 2014

(30) Foreign Application Priority Data
Aug. 9, 2012 (JP) 2012-176717

(51) Int. Cl. H01M 2/10; H01M 2/12

(52) U.S. Cl. CPC H01M 2/1077; H01M 2/1083; H01M 2/1241; H01M 2220/20
USPC 429/56

(57) ABSTRACT

In a power supply device, the gas exhaust valve is integrally coupled to the outer can at the time of opening the gas exhaust valve, and the connecting portion between the outer can and the gas exhaust valve is partially broken at the time of opening the gas exhaust valve by an internal pressure of the outer can, and the gas duct further comprises a joining aperture being connected airtight to the gas exhaust valve, and a duct exhaust portion being connected to the external gas exhaust duct, and the inner diameter d inside the gas duct is at least partially smaller than the outer diameter a of the gas exhaust valve between the joining aperture and the duct exhaust portion.

### CROSS-REFERENCE TO RELATED APPLICATIONS

The present application is a national stage application of international application PCT/JP2013/004658 filed on Aug. 1, 2013, and claims the benefit of foreign priority of Japanese patent application 2012-176717 filed on Aug. 9, 2012, the contents both of which are incorporated herein by reference.

### TECHNICAL FIELD

The present invention relates to a power source device having a plurality of stacked battery cells, and to a vehicle and a storage battery device equipped with the power source device, in particular, to a power source device for a motor driving installed in an electric vehicle such as a hybrid vehicle, fuel-cell vehicle, electric vehicle, or electric auto-bike, or to a power source device configured to supply high current such as in a home or industrial power storage application, and a vehicle and a storage battery device equipped with the power source device.

### BACKGROUND ART

A power supply device having plural battery cells is used as a power source device installed in an electric vehicle such as a hybrid vehicle, an electric vehicle, or a home or industrial power storage. One example of such battery cells is shown in FIG. 15. As shown in the figure, each of battery cells 161 has a gas exhaust valve 1611 which opens a gas exhaust opening 1612 in order to exhaust an inner gas of high temperature or high pressure when the internal pressure is increased at high temperature or the like. In the battery cell 161 having such a gas exhaust opening 1612, it is necessary to safely guide and exhaust the exhausted gas. Therefore, as shown in an explored perspective view in FIG. 16, in the power supply device, a gas duct 166 which is airtightly coupled to each of the gas exhaust openings 1612 of the battery cells 161, is disposed on the upper surface of a battery block 160 in which the battery cells 161 are stacked (for example, refer to patent literature 1).

Further, the duct exhaust portion 166x is provided at the end portions, and as shown in an explored perspective view of FIG. 17, the duct exhaust portion 166x is connected to an external gas exhaust duct 167 of a tube made of rubber or the like, and the gas guided into the gas duct 166 is exhausted outside through the external gas exhaust duct 167. As shown in a sectional view of FIG. 18, when the internal pressure in any one of the battery cells 161 is increased, the power supply device opens the gas exhaust valve 1611, and guides the high pressure gas into the gas duct 166. Further, the high pressure gas is exhausted outside through the external gas exhaust duct 167.

### CITATION LIST

### Patent Literature

Patent Literature 1: Japanese Laid-Open Patent Publication No. 2010-277735

### SUMMARY OF THE INVENTION

The gas exhaust valve provided at the battery cell, is made as a thin portion in a part of a sealing plate of a metal board which closes the top surface of an outer can of the battery cell for cost reduction, and breaks when the internal pressure of the outer can becomes equal to or more than a predetermined value. In the gas exhaust valve of this structure, as shown in a sectional view of FIG. 19, as a result of a break by a strong pressure, one piece or more pieces of metal board can be separated or scattered from the sealing plate 1610 at the time of opening the gas exhaust valve. In this case, the broken metal board can be conveyed by the gas pressure from the gas duct to the external gas exhaust duct, and the inner surface of the tube made of rubber is damaged by a sharp broken metal board, and then a gas leakage might happen.

The present disclosure is developed for the purpose of solving such drawbacks. One non-limiting and explanatory embodiment provides a power supply device, and a vehicle and a storage battery device equipped with the power supply device in which even though a gas exhaust valve breaks, the trouble by a broken piece is prevented.

A power supply device of the present disclosure comprises a battery cell comprising an outer can, and a gas exhaust valve opening a part of the outer can in response to becoming a high pressure in the inside of the outer can, a gas duct guiding the gas exhausted from the gas exhaust valve to an external gas exhaust duct, and the gas exhaust valve is integrally coupled to the outer can at the time of opening the gas exhaust valve, and the connecting portion between the outer can and the gas exhaust valve is partially broken at the time of opening the gas exhaust valve by an internal pressure of the outer can, and the gas duct further comprises a joining aperture being connected airtight to the gas exhaust valve, and a duct exhaust portion being connected to the external gas exhaust duct, and the inner diameter inside the gas duct is at least partially smaller than the outer diameter of the gas exhaust valve between the joining aperture and the duct exhaust portion. Accordingly, when the broken piece broken by the high pressure gas intrudes into the gas duct, it is prevented that the broken piece is exhausted into the external gas exhaust duct. As a result, even when the external gas exhaust duct is made of, for example, a tube of rubber or the like, the damage in the external gas exhaust duct by the broken piece of the gas exhaust valve can be prevented.

Furthermore, in the power supply device of the present disclosure, the duct exhaust portion is smaller than the outer diameter of the gas exhaust valve. Accordingly, it is prevented at the exit portion of the gas duct that the broken piece is exhausted into the external gas exhaust duct.

Furthermore, in the power supply device of the present disclosure, the gas exhaust valve is made of a metal board.

Furthermore, in the power supply device of the present disclosure, the outer can has a tubular shape of a rectangle in a sectional view having a bottom portion, and an opening at the top portion, and the opening of the outer can is closed by a sealing plate made of metal, and the gas exhaust valve is the metal board which is made as a thin portion in a part of the sealing plate, and the gas exhaust valve opens by the metal board being broken from the sealing plate at the time of increasing the internal pressure of the outer can. Accordingly, when the broken piece broken by the high pressure gas intrudes into the gas duct, it is prevented that the broken piece is exhausted into the external gas exhaust duct. As a result, even when the external gas exhaust duct is made of, for example, a tube of rubber or the like, the damage in the external gas exhaust duct by the broken piece of the gas exhaust valve can be prevented. Further, it is prevented that the broken metal piece exhausted from the gas duct unintentionally makes an electrical circuit short by contacting the electrical circuit.

Furthermore, in the power supply device of the present disclosure, in the sealing plate, an elongated hole is formed in a state of the gas exhaust valve opening, and the gas exhaust valve is formed as the thin portion in the sealing plate at the center in the elongated direction in a state of the gas exhaust opening being closed, and in response to becoming a high pressure in the inside of the outer can, the center of the gas exhaust valve is broken, and the gas exhaust valve opens toward outside the outer can. Accordingly, an opening movement of the gas exhaust valve is simplified and surely carried out in response to the increase of the internal pressure.

Furthermore, in the power supply device of the present disclosure, the plural battery cells in a state of being stacked are bound by a binding member in a posture that the sealing plates are trued up, and the gas duct is extended in the stacked direction of the battery cells, and the gas duct is fixed such that the gas duct faces each of the gas exhaust valves of a battery stacked member bound by the binding member of the battery cells.

Furthermore, a vehicle of the present disclosure is equipped with the power supply device. The vehicle comprises an electric motor being energized by electric power that is supplied from the power supply device, a vehicle body having the power supply device and the electric motor, and a wheel being driven by the electric motor, and driving the vehicle body.

Furthermore, a storage battery device of the present disclosure is equipped with the power supply device. The storage battery device comprises a power supply controller controlling charging and discharging of the power supply device, and the power supply device is charged with an external power by the power supply controller, and charging of the power supply device is controlled by the power supply controller.

### BRIEF DESCRIPTION OF DRAWINGS

FIG. 1 is a schematic view showing a power supply device related to an embodiment 1 of the present invention.

FIG. 2 is a schematic view showing a gas duct related to an embodiment 2.

FIG. 3 is a schematic view showing a gas duct related to an embodiment 3.

FIG. 4 is a schematic view showing a gas duct related to an embodiment 4.

FIG. 5 is a perspective view of a power supply device related to an example 1 of the present invention.

FIG. 6 is a sectional view along a line VI-VI of the power supply device shown in FIG. 5.

FIG. 7 is a sectional view and a partial enlarged view along a line VII-VII of the power supply device shown in FIG. 5.

FIG. 8 is a perspective view from the diagonally lower side of the power supply device shown in FIG. 5.

FIG. 9 is an explored perspective view of the power supply device shown in FIG. 5.

FIG. 10 is an explored perspective view of a battery stacked member of the power supply device shown in FIG. 5.

FIG. 11A is a perspective view of a battery cell.

FIG. 11B is a perspective view showing a state that a gas exhaust valve of the battery cell of FIG. 11A opens.

FIG. 12 is a block diagram showing one explanatory embodiment of a hybrid car driven by an engine and a motor in which the power supply device is installed.

FIG. 13 is a block diagram showing one explanatory embodiment of an electric car driven only by a motor in which the power supply device is installed.

FIG. 14 is a block diagram showing one explanatory embodiment of a storage battery device using the power supply device.

FIG. 15 is a perspective view of one example of a conventional battery cell.

FIG. 16 is an explored perspective view in a state that a gas duct is set to a battery block in which the battery cells of FIG. 15 are stacked.

FIG. 17 is an explored perspective view in a state that an external gas exhaust duct is connected to the gas duct of FIG. 16.

FIG. 18 is a sectional view showing a state of the opening of a gas exhaust valve in a power supply device of FIG. 17.

FIG. 19 is a sectional view showing a state that metal board is separated at the time of opening a gas exhaust valve in the power supply device of FIG. 17.

### DESCRIPTION OF EMBODIMENTS

Hereinafter, the embodiment of the present invention will be described referring to drawings. However, the following embodiments illustrate a power supply device, and a vehicle and a storage battery device equipped with power supply device which are aimed at embodying the technological concept of the present invention, and the present invention is not limited to the power supply device, and the vehicle and the storage battery device equipped with power supply device described below. However, the members illustrated in Claims are not limited to the members in the embodiments. In particular, as long as specific descriptions are not provided, it is not intended that the claims be limited to sizes, materials, shapes, and relative arrangements of constitutional members described in the embodiments, which are mere descriptive examples. It is noted that the magnitude or positional relation of the members illustrated in each diagram is sometimes grandiloquently represented, in order to clarify the description. Furthermore, in the description below, identical names and reference numbers represent identical or homogeneous members, and detailed descriptions are appropriately omitted. Moreover, mode may be applied where each element constituting the present invention constitutes a plurality of elements with the use of the same member, thereby serving the plurality of elements with the use of one member, or, in contrast, mode may be realized where a function of the one member is shared by a plurality of members. Also, a portion of examples and the content described in the embodiments can be applied to other examples and another embodiment.

### Embodiment 1

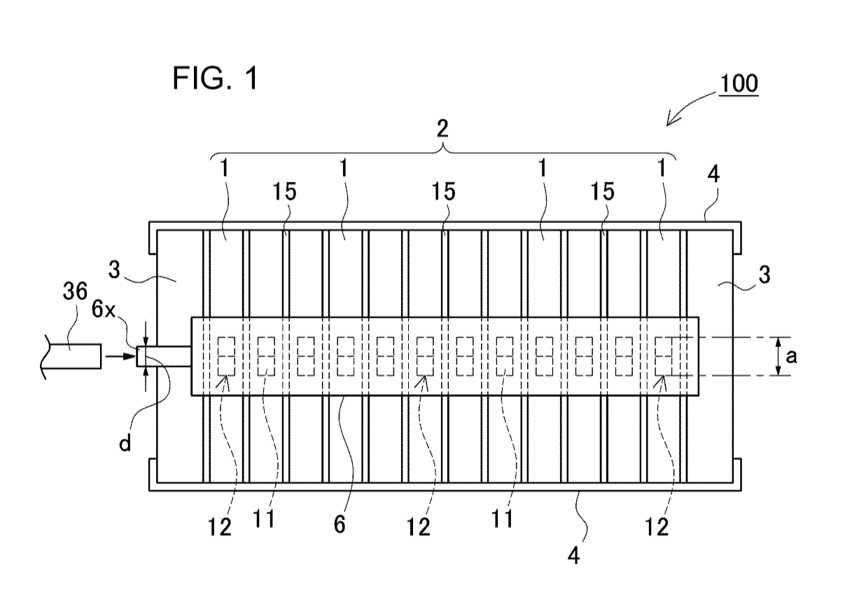

A schematic view of a power supply device 100 related to an embodiment 1 of the present invention, is shown in FIG. 1. The power supply device 100 shown in this figure comprises a battery stacked member 2 in which plural battery cells 1 are stacked, and a gas duct 6. In the battery stacked member 2, plural sheets of the battery cells 1 are stacked interposing spacers 15, and end plates 3 are disposed at both end surfaces, and then the end plates 3 are bound by binding members 4. The spacers 15 are made of insulating material in order to insulate the battery cells 1 from each other. Further, the end plates 3 are made of high rigidity material, for example, metal or the like in order to bind the battery stacked member 2 in a stacked state. In addition, in the same way, the binding members 4 are made of high rigidity material, for example, metal or the like. Here, in each of the binding members 4, a metal board is bent in a U-shaped cross-sectional shape, and end portions of the metal boards as the binding members 4 are fixed at the end plates 3 by screw or the like.

Each of the battery cells 1 has a rectangular box shape of an outer can. The upper surface of the outer can defines a gas exhaust opening 12, and a gas exhaust valve 11 closes the gas exhaust opening 12. The gas exhaust valve 11 is made so as to open in response to becoming a high pressure in the inside of the outer can.

This gas exhaust valve 11 at the time of closing is integrally connected to the outer can. On the other hand, at the time of opening, a part of connection between the outer can and the gas exhaust can 11 breaks. In the embodiment of FIG. 1, the gas exhaust valve 11 is a metal board, and it is fixed to the gas exhaust opening 12 by welding or integrally with the outer cans. The connecting portion between the gas exhaust valve 11 and the gas exhaust opening 12 is broken by the internal pressure of the gas, and then the gas exhaust opening 12 is opened.

On the other hand, the gas duct 6 has a hollow prism shape, and a duct exhaust portion 6x opens at an end portion of the gas duct 6.

At the bottom surface side of the gas duct 6, a joining aperture 6b opens at the position corresponding to the gas exhaust valve 11 of each of the battery cells 1. The joining apertures 6b are respectively coupled airtightly to the gas exhaust openings 12 in a state of the gas exhaust valve 11 opening, and the high pressure gas exhausted from the battery cells 1 is guided within the gas duct 6. Further, in the inner portion of the gas duct 6, one end of the gas duct 6 is closed, and the other end of the gas duct 6 is opened. The duct exhaust portion 6x is coupled to an external gas exhaust duct 36, and the gas is safely exhausted outside. Here, the inner shape of the gas duct 6 can be an arbitrary shape, for example, such as, a tubular shape, an inverted U-shape, a U-shape, or the like.

The inner diameter inside the gas duct 6 is at least partially smaller than the outer diameter of the gas exhaust valve 11 between the joining aperture 6b and the duct exhaust portion 6x. By this structure, even though the broken gas exhaust valve 11 is separated from the outer can, and intrudes into the gas duct 6, it is stopped by the portion of the smaller inner diameter, and it is not exhausted from the gas duct 6. By this, the gas exhaust valve 11 intrudes into

In the embodiment of FIG. 1, the inner diameter d of the duct exhaust portion 6x is smaller than the outer diameter a of metal board which constitutes the gas exhaust valve 11. By this structure, it is prevented at an exit that metal board intrudes into the external gas exhaust duct from the gas duct 6. Here, the outer diameter a of the gas exhaust valve 11 means the maximum width among widths of the gas exhaust valve 11. For example, when a rectangular shape of the gas exhaust valve 11 is used, the length of the long side is the outer diameter a of the gas exhaust valve 11. Further, when not the whole gas exhaust valve, but only a part thereof is broken, separated from the outer can, among sizes in the separated portion of the gas exhaust valve, the outer diameter a is the maximum width.

The outer can preferably has a tubular shape having a bottom portion, and an opening at one surface. A sealing plate 10 closes the opening of the outer can. Further, preferably, the gas exhaust valve is made as a thin portion in a part of the sealing plate made of a metal board. Namely, along the outer shape of the gas exhaust opening 12 formed as an elongated hole, the treatment of pressing, cutting, or the like makes the thickness of the sealing plate 10 thin. By this structure, at the time of increasing the internal pressure of the outer can, the region of the thin portion in the sealing plate 10 breaks, and piece of metal board corresponding to the gas exhaust valve 11 is separated from the sealing plate 10, and then the gas exhaust valve 12 opens. By this structure, the gas exhaust valve 11 is formed on the outer can at low cost. Here, the gas exhaust valve of the present disclosure is not limited to this structure, and, for example, the gas exhaust valve is made as a separate part, and it can be fixed to, and close the opening portion of the gas exhaust opening by welding, gluing, or the like.

More preferably, it comprises such that the opened gas exhaust valve 11 is not or hardly separated from the outer can by adjusting the thickness of the thin portion. For example, the whole periphery of the gas exhaust valve 12 as a boundary between the gas exhaust opening 12 and the gas exhaust valve 11 is not made as the uniform thin portion, and a part (for example, one end edge in the elongated hole of the gas exhaust opening 12) thereof is made relatively thick. As a result, when the thin portion breaks at the time of increasing the internal pressure of the outer can, the relative thick portion remains without breaking. Therefore, while the gas exhaust opening 12 is opened, the gas exhaust valve 11 can remain without the gas exhausting valve 11 separated from the outer can. In this way, while the gas exhaust valve 11 opens at the time of increasing the internal pressure, piece of metal board is not separated from the outer can even by opening valve, and then it is prevented that piece of metal board intrudes into the gas duct or the external gas exhaust duct.

The same thing can be applied to the structure in which the gas exhaust valve is fixed to the gas exhaust by welding, gluing, or the like. Namely, in the fixing strength between the gas exhaust valve and the gas exhaust opening, the fixing strength of a portion which is needed to be broken at the time of opening valve is made relatively stronger than that of a portion which is needed not to be broken at the time of opening valve. Accordingly, while the gas exhaust valve opens, piece of metal board is not separated, and then troubles caused by a break of the gas exhaust valve are surely prevented.

Here, the thin portion formed in the sealing plate is included in the gas exhaust opening in this specification. Namely, not only a structure that the gas exhaust opening is opened in the sealing plate in advance, but also a structure that the gas exhaust opening appears for the first time at the time of a break, namely, opening the gas exhaust valve, is called the gas exhaust valve in this specification.

### Embodiment 2

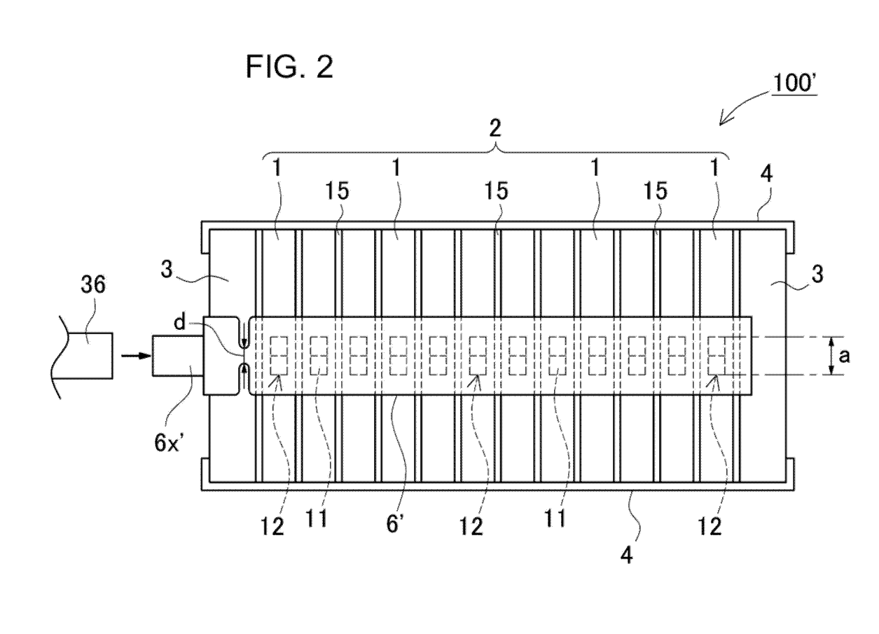

The above embodiment explains a case that the inner diameter d of the duct exhaust portion 6x at the end portion of the gas duct 6 is smaller than the outer diameter a of the gas exhaust valve 11. However, it is not necessarily limited to this position, and the middle in the tubular channel of the gas duct can be narrow, and in the same way, the damage in the external gas exhaust duct of a tube made of rubber or the like by piece of metal board can be prevented. For example, as shown in FIG. 2 as the embodiment 2, a part of a gas duct 6′ is partially narrowed, and the inner diameter d becomes small in this portion, and then the exhaust of piece of metal board is prevented. According to this structure, the exhaust of piece of metal is effectively prevented without the inner diameter of a duct exhaust portion 6x′changed.

### Embodiment 3

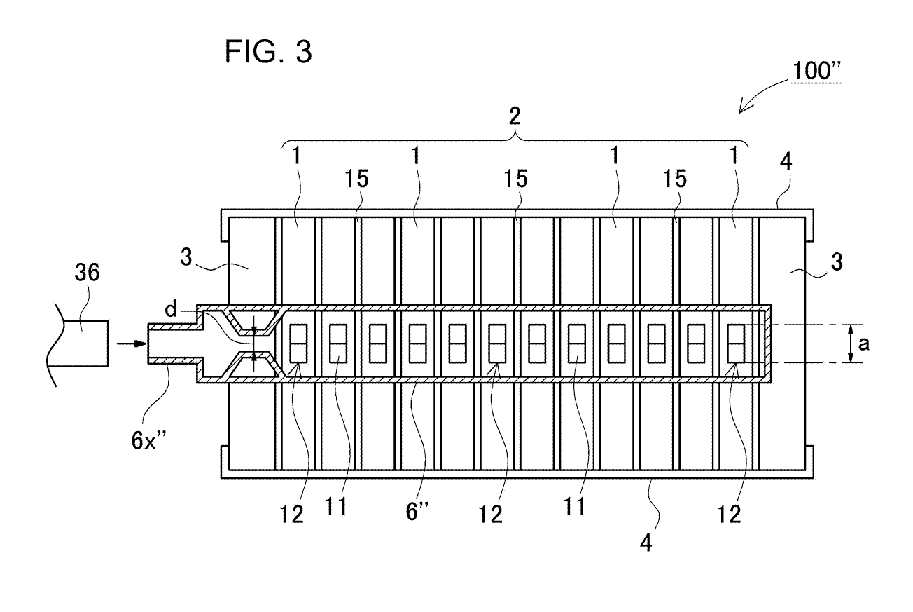

Further, regarding the narrowed shape, besides the outer shape of the gas duct of itself being narrowed, as shown in the embodiment 3 of FIG. 3, an inner portion of a gas duct 6″can be narrowed. By this structure, only the inner portion of the inner diameter d is partially narrowed without the outer shape of the gas duct 6″changed, a decrease of strength in the gas duct 6″can be prevented. The inner diameter of a duct exhaust portion 6x″ is also unchanged in the same as the embodiment 2. Thus, being not limited to the end portion of the gas duct, at least a part of the inner portion in the tubular channel of the gas duct is narrowed, and then it is prevented that the gas exhaust valve 11 is exhausted outside from the gas duct.

As mentioned above, the exit or the middle in the tubular channel of the gas duct, namely at between the joining aperture and the duct exhaust portion, by providing a gas duct portion in which the inner diameter of the gas duct is smaller than the outer diameter of the gas exhaust valve, when the gas exhaust valve is broken by the high pressure gas and the broken piece intrudes into the gas duct, it is stopped inside the gas duct, and it is prevented that the broken piece is exhausted into the external gas exhaust duct. As a result, even when the external gas exhaust duct is made of, for example, a tube of rubber or the like, the damage in a gas exhaust channel including the external gas exhaust duct by the broken piece of the gas exhaust valve can be prevented.

### Embodiment 4

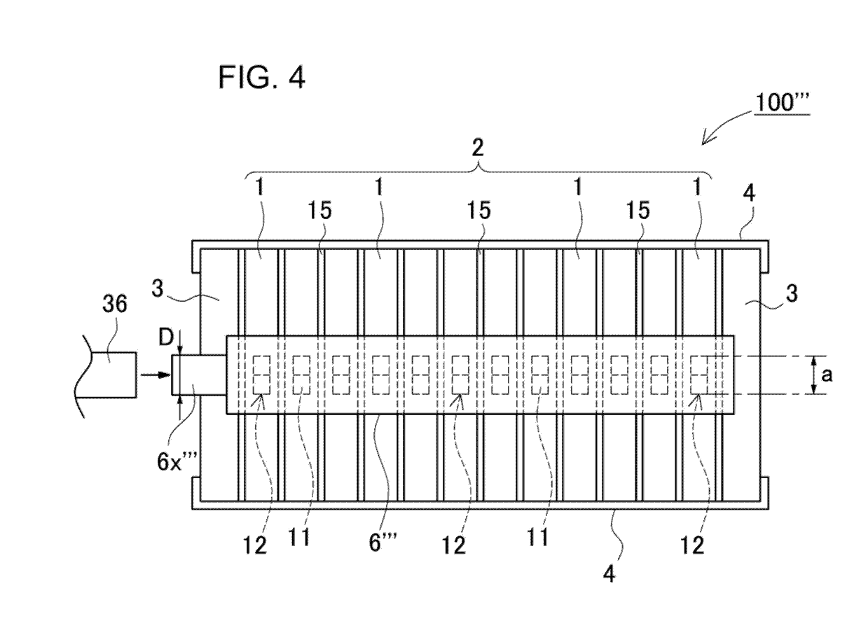

On the other hand, when the inner diameter of the gas duct is narrowed, the broken piece of metal board piece is stopped inside the gas duct, and then, it is considered, the exhaust of the gas is prevented by blocking the gas exhaust channel. As shown in FIG. 4, conversely, the inner diameter D of a gas duct 6″(for example, the inner diameter of a duct exhaust portion 6x″) is bigger than the outer diameter a of metal board which constitutes the gas exhaust valve 11, and such blocking is prevented, and the gas is smoothly exhausted from the gas duct 6″. In this case, in order that the broken metal piece exhausted from the gas duct does not damage other parts, or does not make an electrical circuit short, etc., other structures are necessary. For example, the external gas exhaust duct is made of hard material of resin, metal, or the like, and the electrical circuit is separated in order to avoid contacting between the broken metal piece and the electrical circuit.

In a power supply device 100″ shown in FIG. 4, plural battery cells 1 having the rectangular box shape are stacked interposing the spacers 15 therebetween, and the end plates 3 are disposed at both end surfaces of this battery stacked member 2, and then the end plates 3 are bound by binding members 4. The gas duct 6″ is provided on the upper surface of the battery stacked member 2. The gas duct 6″ has plural joining apertures, and each of the joining apertures 6b is disposed at the position corresponding to the gas exhaust opening 12 of each of the battery cells 1. Further, at one end portion of the gas duct 6″, the duct exhaust portion 6x′″opens, and then this the duct exhaust portion 6x″ is coupled to an external gas exhaust duct 36″. In this case, the inner diameter of the duct exhaust portion 6x″ is bigger than the outer diameter of the gas exhaust valve 11 which closed the gas exhaust opening 12. Therefore, it can be prevented that metal board which constitutes the gas exhaust valve 11, blocks the inner portion of the gas duct 6′″ or the duct exhaust portion 6x″.

### Example 1

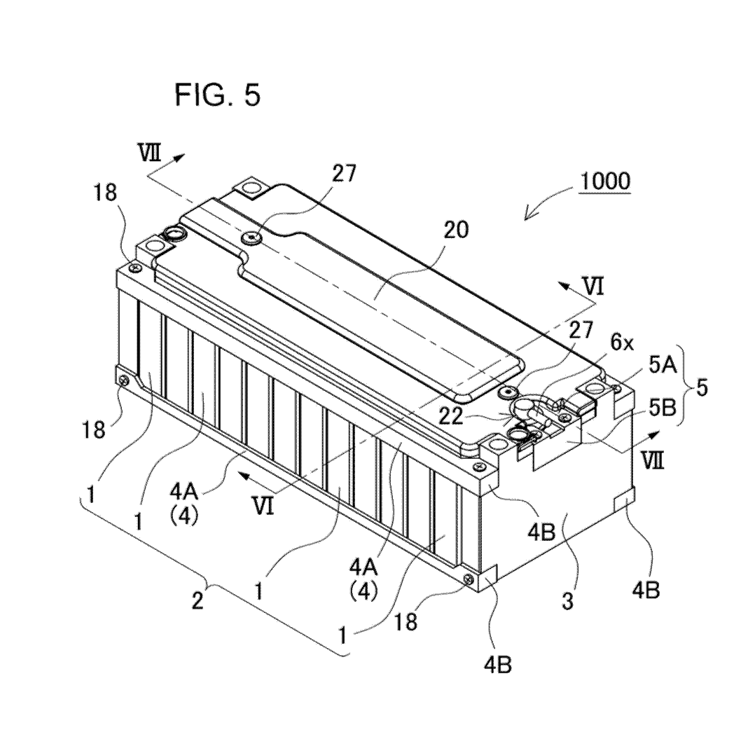

A power supply device 1000 shown in FIG. 5 to FIG. 11B, comprises the plural battery cells 1 which each have the sealing plate 10 including the gas exhaust opening 12 having the gas exhaust valve 11, the battery stacked member 2 in which plural battery cells 1 are stacked, and the gas duct 6 which is fixed to one surface of this battery stacked member 2 such that the gas duct 12 is coupled to the gas exhaust opening 12 in each of the battery cell 1. Further, the power supply device 1000 comprises end plates 3 which are disposed at both end surfaces of the battery stacked member 2, the binding members 4 which bind the battery stacked member 2 through the end plates 3 in the stacked direction. Further, the binding member 4 comprises a second binding member 5 which faces and is disposed on the one surface of the battery stacked member 2 on which the gas duct 6 is fixed, and is fixed to the end plate 3. The second binding member 5 binds the battery stacked member 2 in the stacked direction through the end plates 3. In the power supply device 1000, the gas duct 6 is disposed in a predetermined position of the gas duct 6.

### (Battery Stacked Member 2)

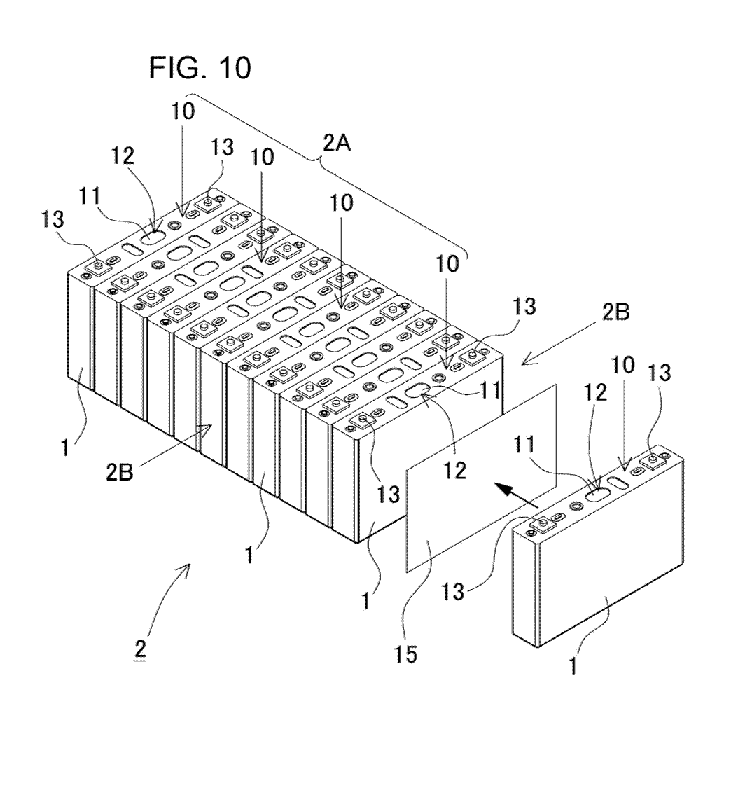

The power supply device 1000 shown in FIG. 5 to FIG. 11B, has the battery stacked member 2 in which the plural battery cells 1 of the rectangular box shape in the outer appearance are stacked. Each of the battery cells 1 has the rectangular box shape of the outer can, and the gas exhaust valve 11 to exhaust the gas generated inside the outer can. The battery cell 11 has the gas exhaust opening 12 on the surface of the outer can to exhaust the gas from the gas exhaust valve 11. In the battery stacked member 2 shown in FIG. 10, the plural battery cells 1 are stacked in a posture that the sealing plate 10 are disposed in the approximately same plane, and the plural gas exhaust openings 12 are disposed on a first surface 2A. Further, in the battery stacked member 2, the plural battery cells 1 are stacked in a posture that the sealing plates 10 having the gas exhaust valve 11 are disposed on the upper surface.

### (Battery Cell 1)

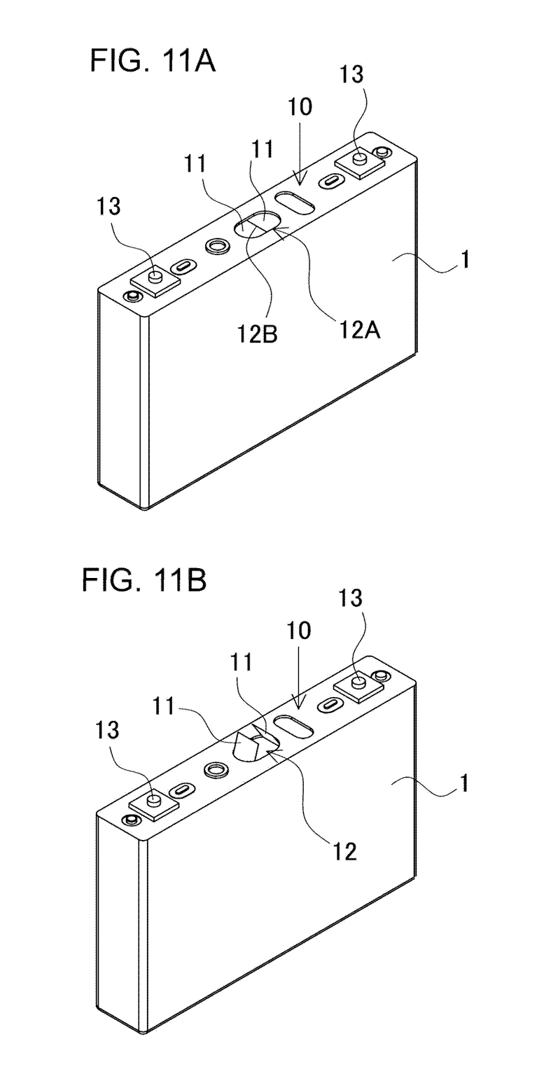

As shown in perspective views of FIG. 10 and FIG. 11A, in the battery cells 1 the width is longer than the thickness, in other words, the battery cell 1 has a rectangular box shape which is thinner than the width. The plural sheets of the battery cells 1 which are stacked in the thickness direction, constitute the battery stacked member 2. Each of the battery cells 11 is a lithium ion secondary battery. But, as the battery cell, a secondary battery, for example, a nickel hydride battery, a nickel cadmium battery, or the like can be used.

The battery cell 1 of FIG. 10 has both wide rectangular surfaces, and the battery stacked member 2 is constituted by facing the wide rectangular surfaces of the battery cells 1. In each of the battery cells 1, positive and negative electrode terminals 13 project at both end portions of the upper surface of the sealing plate 10, and the gas exhaust opening 12 of the gas exhaust valve 11 is provided at the center thereof. In the rectangular battery cell 1, the tubular outer case having the bottom portion closing the bottom and the upper opening, is formed by pressing the metal board, and the upper opening is airtightly closed by the sealing plate 10. The sealing plate 10 is a flat metal board, and its outer shape is the shape of the upper opening. The sealing plate 10 is fixed to the peripheral edge of the outer case by laser welding, and airtightly closes the upper opening of the outer can. In the sealing plate 10 fixed to the outer can, positive and negative electrode terminals 13 are fixed at both end portions of the upper surface of the sealing plate 10, and the gas exhaust valve 11 inside the gas exhaust opening 12 is provided.

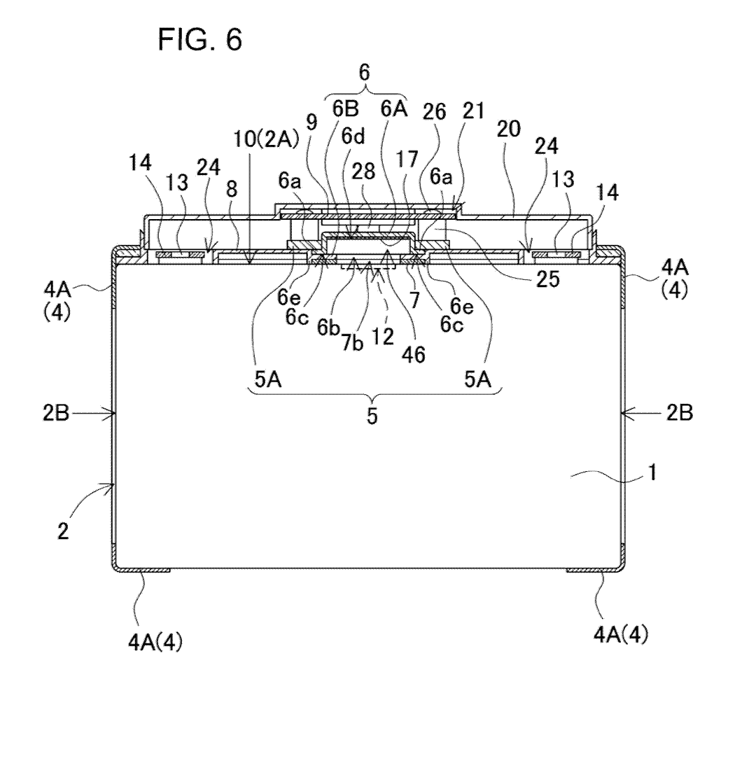

The gas exhaust valve 11 closes the gas exhaust opening 12 in the normal state as shown in the sectional view of FIG. 6. On the other hand, when the internal pressure of the battery cell 1 increases more than the predetermined pressure, the gas exhaust valve 12 opens. Namely, when the internal pressure of the outer can reached the predetermined pressure, as shown in FIG. 11A and FIG. 11B, the gas exhaust valve 11 breaks, and then the gas exhaust opening 12 is opened. By opening the gas exhaust valve 11, the inside of the battery cell 1 is released outside through the gas exhaust opening 12, and the increase of the internal pressure is prevented by releasing the internal gas.

In the case of FIG. 11A, a break portion 12A of a track shape at the center in the longitudinal direction of the sealing plate 10, is provided as the gas exhaust valve 11. In the gas exhaust valve 11, the break portion 12a is broken at the predetermined pressure, and the gas exhaust opening 12 of the track shape is opened. The longitudinal direction of the track shape of the gas exhaust opening 12 is formed in the same posture as the longitudinal direction of the sealing plate 10.

Further, a second break portion 12B is provided at the center in the longitudinal direction of the gas exhaust opening 12. The second break portion 12B is made so as to be more easily broken than the break portion 12A of the track shape. Concretely, while the break portion 12A of the track shape and the second break portion 12B are formed by making the thickness of the sealing plate 10 thin, the second break portion 12B is formed so as to be thinner than the break portion 12A of the track shape. From this, the second break portion 12B in which the strength is weak by making thinner, can be broken prior to the break portion 12A of the track shape. As a result, as shown in FIG. 11B, the gas exhaust valve 11 which is broken at the second break portion 12B, opens in the way how the center portion is split like double doors opening from the center. This structure has a merit that an opening movement of the gas exhaust valve 11 is reasonably and surely carried out.

It is desirable that the gas exhaust valve 11 is not separated from the sealing plate 10. Because of this, in the beak portion of the track shape 12A, the end edge portion of the break portion of the track shape 12A is made so as to be thicker than other portion other than the end edge portion. From this, regarding the connection between the gas exhaust valve 11 and the gas exhaust opening 12, the end edge portion of the gas exhaust valve 11 is hardly broken, and then the probability of piece of metal board which constitutes the gas exhaust valve 11 intrudes inside the gas duct 6, can be decreased. Namely, the thin portion which constitutes the break portion is thin at the second break portion 12B of the center, and thick at the peripheral portion of it as the break portion of the track shape 12A, and especially thick at the base of the gas exhaust valve 11. From this, at the time of high pressure, the center of the gas exhaust opening 12A easily breaks and opens, and the probability that the gas exhaust valve 11 is separated from the outer can leaving the base portion of the gas exhaust valve 11, can be decreased.

Moreover, at the time of a very high pressure, even though piece of metal board is blown as shown in FIG. 19, by the inner diameter of the duct exhaust portion 6x being made smaller than the piece of the metal board as mentioned below, it is possible to stop inside the gas duct 6.

Here, in the case of FIG. 11A, the gas exhaust valve 11 is integrally formed with the sealing plate 10. But, needless to say, the gas exhaust valve can be made as a separate part, and it can be fixed to the gas exhaust opening which is opened in advance by welding, gluing, or the like.

The plural stacked battery cells 1 are connected in series or/and parallel by connecting the positive and negative electrode terminals 13. In the power supply device, the positive and negative electrode terminals 13 of the adjacent battery cells 1 are connected in series or/and parallel through bus bars 14. When the adjacent battery cells 1 are connected in series, the output voltage is increased. When the adjacent battery cells 1 are connected in parallel, the charging and discharging current is increased.

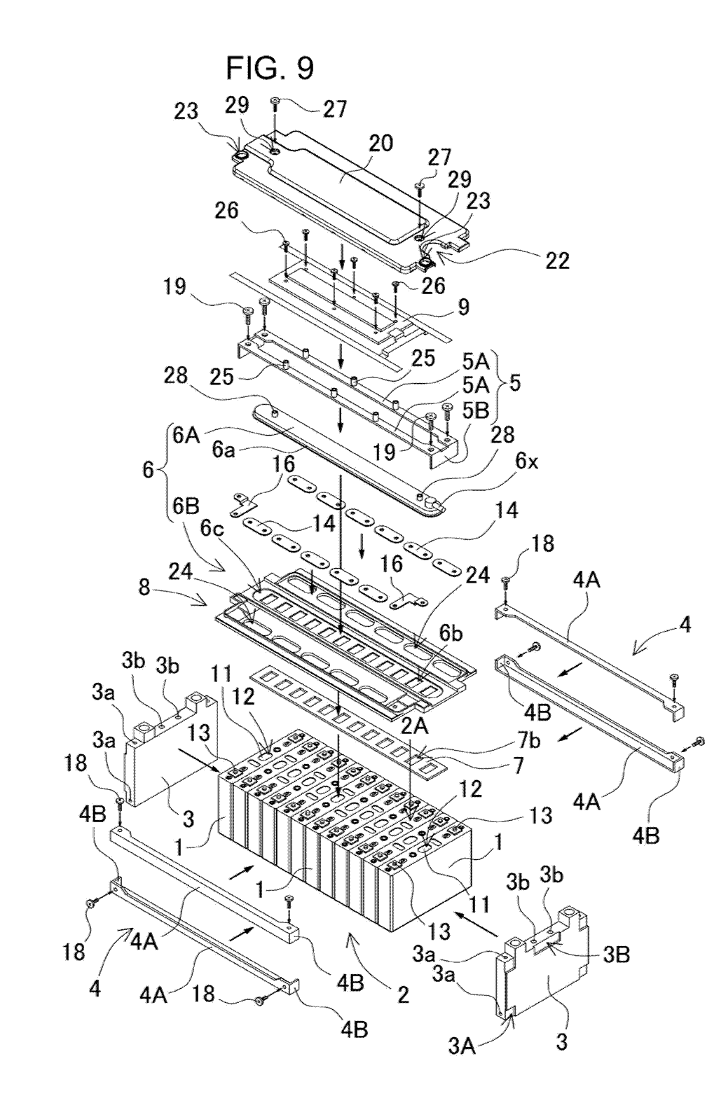

The battery stacked member 2 shown in FIG. 9 and FIG. 10, twelve of the battery cells 1 are stacked interposing the separator 15, and these battery cells 1 are connected in series. In the battery stacked member 2 of the figures, the adjacent battery cells 1 are reversely arranged, and the adjacent electrode terminals 13 are coupled by the bus bar 14 at both sides, and the adjacent battery cells 1 are connected in series, and then all the battery cells 1 are connected in series. However, the present invention is not limited to the number of the battery cells in the battery stacked member and its connecting state.

### (Spacer 15)

As shown in FIG. 10, in the battery stacked member 12, the spacers 15 are sandwiched and fixed between the stacked battery cells 1. The spacers 15 insulate the adjacent battery cells 1 from each other. The spacers 15 shown in the figures are an insulating sheets. A plastic sheet can be used as the insulating sheet. Since the thickness of the spacer 15 made of the plastic insulating sheet can be made thin, the whole length of the battery stacked member 2 can be short, and compact. The sheet shape of plastic can be used as the spacer. Further, the spacer can also be formed such that the battery cell is press-fitted into the spacer, and the adjacent battery cells can be stacked without slippage. In addition, the molded spacer of plastic can include a cooling space through which a cooling gas of air or the like passes, and then the battery cells can also be cooled by the cooling gas. In this structure, the outer can of the battery cells 1 can be directly and effectively cooled by forcibly blowing cooled air to the cooling spaces. Further, as thermal conductivity of plastic is low, the plastic spacer can effectively prevent thermal runaway of the adjacent battery cells.

As mentioned above, the battery cells 1 which are stacked and insulated by the spacers 15, can be made of metal, for example, aluminum or the like in the outer can. Here, the battery stacked member does not necessarily need to interpose the spacers between the battery cells. For example, the outer can of the battery cell is made of insulating material, or the outer portion of the outer can of the battery cell can be coated with an insulating cover or an insulating paint. By these, the adjacent battery cells are insulated from each other without the spacers. Further, the battery stacked member having no space between the battery cells, can be directly cooled by using coolant or the like, without using air-cooled system cooled by forcibly blowing cooled air to between the battery cells.

### (End Plate 3)

A pair of the end plates 3 are disposed at both end surfaces of the battery stacked member 2, and the battery stacked member 2 are sandwiched and fixed from both ends by a pair of the end plates 3. The end plates 3 have the same outer shape and size as the battery cell of the rectangular shape, and the battery stacked member 2 is sandwiched and fixed from both end surfaces. The end plates 3 of FIG. 9 are made of metal. The end plates made of metal can rigidly and stably sandwich and fix the battery stacked member from both ends. Here, the end plate can be also entirely made of plastic. Or a main body portion made of plastic can be coupled to and reinforced by a reinforcing metal fitting.

The end plates 3 shown in the figures have press fit recesses 3A, 3B of the binding member 4, the second binding member 5 at the outer surface thereof in order to fix the binding member 4 and the second binding member 5 at a fixed position. The end plates 3 have the press fit recesses 3A into which connecting portions 4B provided at both ends of the binding member 4 are press-fitted, at the four corners of the outer surface thereof in order to dispose and fix the binding member 4 in the fixed position. In the end plates 3 shown in the figures, the shape of the press fit recess 3A is made so as to press-fit the connecting portion 4B of the binding member 4 into the press fit recess 3A. The end plates 3 have the press fit recesses 3B into which connecting portions 5B provided at both ends of the second binding member 5 are press-fitted, at the top portion of the outer surface thereof in order to dispose and fix the second binding member 5 in the fixed position. In the end plates 3 shown in the figures, the shape of the press fit recess 3B is made so as to press-fit the connecting portion 5B of the second binding member 5 into the press fit recess 3B.

Further, the end plates 3 have the screw holes 3a, 3b at the outer surface thereof into which screws 18, 19 are screwed to fix both end portions of the binding members 4 and the second binding members 5. The end plates 3 shown in the figures have the screw holes 3a at both left and right end portions of the upper surface of the end plates 3 into which the screws 18 are screwed to fix both end portions of a pair of the binding members 4 which are disposed at the top end portions in both side surfaces 2B of the battery stacked member 2. Also, the end plates 3 have the screw holes 3b at the lower end portions of both side surfaces of the end plates 3 into which the screws 18 are screwed to fix both end portions of a pair of the binding members 4 which are disposed at the lower end portions in both side surfaces 2B of the battery stacked member 2. Further, the end plates 3 have the screw holes 3b at the center portions of the top surfaces of the end plates 3 into which the screws 19 are screwed to fix both end portions of the second binding members 5 which are disposed on a first surface 2A of the battery stacked member 2. In the above structure, the axle direction of the screw 18, 19 which are screwed into the end plates 3, crosses the stacking direction of the battery stacked member 2. Therefore, in a state that the power supply device vibrates by receiving the strength from outside, the shearing force which is applied to the axles of the screws 18, 19 screwed into the end plate 3, is reduced. And while the screws 18, 19 are protected, the strong connection strength can be realized. Further, when the whole length of the screw 18, 19 is longer than the thickness of the end plate 3, namely the whole length of the screw 18, 19 are made longer, those can be more strongly connected.

### (Binding Member 4)

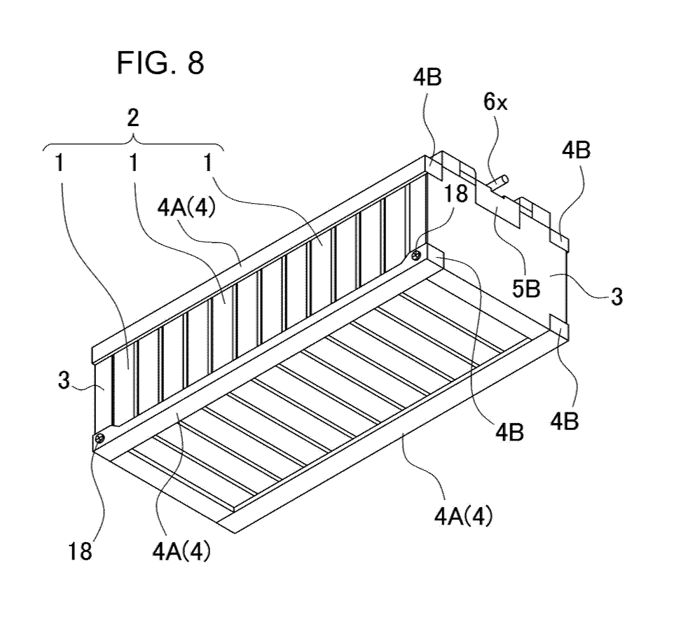

As shown in FIG. 5 and FIG. 8, the binding members 4 are extended in the stacking direction of the battery stacked member 2, and both ends thereof are fixed to the end plates 3, and then the battery stacked member 2 is bound in the stacking direction. The binding members 4 shown in the figures, are disposed, facing both side surfaces 2B other than the first surface 2A of the battery stacked member. Thus, in the binding structure in which the binding members 4 are disposed at both side surfaces of the battery stacked member 2, the plural battery cells 1 are more surely bound in the stacking direction. But, the binding member does not necessarily need to be disposed at both side surfaces of the battery stacked member. The binding member can be disposed at the upper surface or the bottom surface in addition to both side surfaces, and also can be disposed only at the upper surface or the bottom surface without at both side surfaces.

The binding member 4 is a metal board having a predetermined width and a predetermined thickness along the surface of the battery stacked member 2. As the binding member 4, a metal board of iron or the like, and preferably a steel board, can be used. In the binding member 4 made of the metal board, the connection portions 4B connected to the end plates 3 are provided at both ends of a binding portion 4A. The binding member 4 of the figures has the connection portions 4B which are approximately perpendicularly bent along the outer surface of the end plate 3 By connecting the connecting portions 4B at both ends of the binding members 4 and the end plates 3, the connecting portions 4B of the binding members 4 are engaged with a pair of the end plates 3 disposed at both ends of the battery stacked member 2, and the battery stacked member 2 are sandwiched and fixed by a pair of the end plates 3 so as to be a predetermined space between a pair of the end plates 3. In the binding member 4 of FIG. 9, the press fit recesses 3A provided at the four corners of the end plates 3, are coupled to the connecting portion 4B, and then a pair of the end plates 3 are coupled by the four binding member 4. Therefore, the connecting portions 4B of the binding member 4 are bent so as to be along the press fit recesses 3A of the end plates 3. Further, the binding members 4 are fixed to the end plates 3 at both end portions thereof by the screws 18. The binding members 4 of the figures have through holes into which the screws 18 are inserted, and the through holes are opened at both end portions of the binding portion 4A. In a state that the connecting portions 4B at both ends are coupled to the press fit recesses 3A, the screws 18 are inserted into the through holes, and the screws 18 are screwed into the screw holes 3a of the outer surface of the end plates 3, and then the binding member 4 are fixed to a pair of the end plates 3.

According to this structure, as mentioned above, the axle direction of the screw 18, 19 which are screwed into the end plates 3, crosses the stacking direction of the battery stacked member 2. And while the screws 18, 19 are protected, the strong connection strength can be realized. In addition to this, as the connecting portions 4B of the connecting member 4 are engaged with the end plates 3, the strong connection strength can be realized also in the stacking direction of the battery stacked member 2. Also, in this structure, as the screws 18, 19 are not located in the stacking direction of the battery stacked member 2, increasing in size of the power supply device can be suppressed or reduced. Concretely, as the size of the end plate 3 is the about same as the size of the outer can of the battery cell 1, the size of the electrode terminal 13 of the battery cell 1 is a spared space in the vertical direction of the end plate 3. Therefore, by the above structure, increasing in size of the power supply device can be suppressed or reduced.

Further, the binding members 4 shown in FIG. 6 and FIG. 9 have L-shapes in the lateral sectional view of the binding portions 4A, and the L-shapes of the binding portion 4A are disposed at the four corners of the battery stacked member 2. The inner surfaces of the binding portions 4A of this shape are disposed along the corner portions of the battery stacked member 2, and the vibration in the vertical and horizontal directions of the stacked battery cells 1 is suppressed. It is a reason why the vertical portions along the side surfaces 2B of the battery stacked member 2 prevent the vibration in the horizontal direction of the battery cells 1, and the lateral portion along the upper surface and the bottom surface of the battery stacked member 2 prevent the vibration in the vertical direction of the battery cells 1. Further, as the binding portions 4A have the L-shapes in the lateral sectional view, the bending strength of the binding portion 4A can be strong. Here, all of the binding portions 4A do not necessarily need to have the L-shapes in the lateral sectional view. Only the binding portions 4A of the upper binding member can have the L-shapes in the lateral sectional view, and can be disposed at the upper corners of the battery stacked member. Or only the binding portions 4A of the lower binding member can have the L-shapes in the lateral sectional view, and can be disposed at the lower corners of the battery stacked member. And, the binding members do not necessarily need to be disposed along the corners of the battery stacked member. The binding members can be disposed along both side surfaces of the battery stacked member. Also, the binding members can be disposed along both side surfaces and the bottom surface of the battery stacked member. Moreover, the binding member can be the board shape along the side surface of the battery stacked member. The main fixing part of the board shape can have an opening portion opened.

### (Gas Duct 6)

The gas duct 6 is disposed on the first surface 2A of the upper surface of the battery stacked member 2 in a position where the gas duct 6 faces the gas exhaust openings 12 so as to guide the gas exhausted from the gas exhaust valves 11 outside the power supply device. The gas duct 6 is designed to have an enough strength preventing destruction or damage by the exhausted gas having high pressure or high temperature, and preferably made of plastic, for example, polybutylene terephthalate, which is excellent in heat-resisting property, chemical resistance. But the gas duct can be made of plastic, for example, nylon resin, epoxy resin, or the like. Here, the structure in which the resin gas duct is molded, is excellent in workability, and relaxes the restriction on the design.

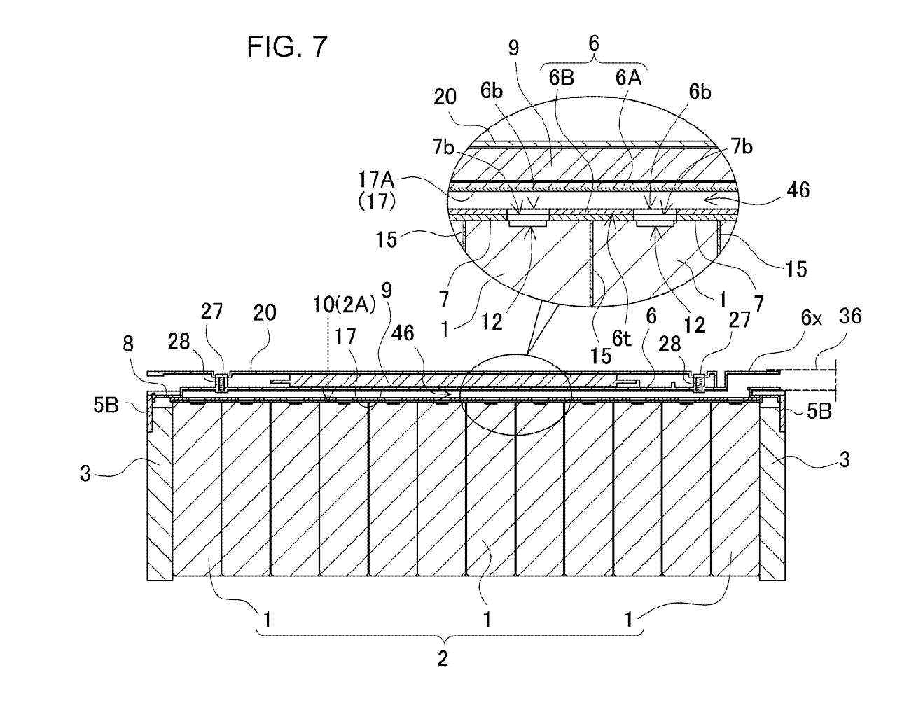

The gas duct 6 shown in FIG. 6 and FIG. 7 is formed into a hollow shape, and has the joining apertures 6b connected to the gas exhaust opening 12 in a position of facing the gas exhaust opening 12 of each of the battery cells 1 on the facing surface to the battery stacked member 2. The gas duct 6 shown in the figures has a tubular shape of a gas passage 46, and the gas exhausted from the gas exhaust openings 12 of the battery cells 11, flows into the gas passage 46 through the joining apertures 6b.

(Duct Exhaust Portion 6x)

Further, as shown in FIG. 7 to FIG. 9, the gas duct 6 has the duct exhaust portion 6x at one end portion thereof to exhaust the inner gas of the gas duct 6 outside. In the gas duct 6 shown in the figures, the duct exhaust portion 6x comprises a hollow projection projecting from the upper surface of the gas duct 6, and a tubular pipe connected to the hollow projection so as to be connected with consecutive space to the gas passage 46 In the gas duct 6 shown in FIG. 7, the duct exhaust portion 6x is connected to the external gas exhaust duct 36, and the gas flowing in from the gas duct 6 is exhausted outside.

The inner diameter d of the duct exhaust portion 6x is smaller than the outer diameter of metal board of the gas exhaust valve 11. By this structure, when the gas exhaust valve 11 is broken by the high pressure gas and the broken piece intrudes into the gas duct 6, it is prevented that the broken piece is exhausted into the external gas exhaust duct. As a result, even when the external gas exhaust duct is made of, for example, a tube of rubber or the like, the damage in the gas exhaust channel including the external gas exhaust duct by the broken piece of the gas exhaust valve can be prevented.

Further, a metal layer 17 is provided on the inner surface of the gas duct 6 in order to improve resisting property against the gas of high temperature exhausted from the gas exhausted openings 12. The metal layer 17 of the gas duct 6 is formed on the inner surface of the facing surface to the gas exhaust openings 12, namely the inner surface facing to the surface having the joining apertures 6b. The gas duct 6 shown in FIG. 6 and FIG. 7, has a rectangular tubular shape of the gas passage 46 therein, and the metal layer 17 is provided only the upper surface 6t of the gas duct 6, namely the inner surface facing to the bottom surface having the joining apertures 6b, and then the other inner surfaces of the gas duct 6 is exposed without the metal layer 17. In this structure, the gas of high temperature exhausted from the gas exhaust openings 12 directly collides with the metal layer 17, and the upper surface 6t of the gas duct 6 is surely protected. As the gas of high temperature emitted from the gas exhaust opening 12, is normally emitted in the vertical direction to the sealing plate 10 of the battery cell 1, the gas of high temperature which collides with the upper surface 6t side, is most apt to receive the influence by heat. Therefore, by forming the metal layer 17 only on this portion, the metal layer 17 is formed only on the portion of a necessity minimum, and its resisting property can be maintained. But, the metal layer can be also formed on the surfaces besides the inner surface facing to the joining apertures, for example, on the inner side surfaces of the gas duct

In the gas duct 6 shown in FIG. 6 and FIG. 7, by fixing the metal sheet 17A to the inner surface of the gas duct 6, the metal layer 17 is provided. Here, in place of the metal sheet, thin metal board as the metal layer can be fixed to the inner surface of the gas duct. The metal layer 17 of the metal sheet 17A or the thin metal board has an adhesive layer provided on the one surface thereof, and is stuck on the inner surface of the gas duct 6 through the adhesive layer, or is stuck on the inner surface of the gas duct 6 by an adhesive, a two-faced adhesive tape, or the like.

The gas duct 6 shown in FIG. 9 is divided into a first duct 6A and a second duct 6B. The first duct 6A and the second duct 6B are separated in the vertical direction to the sealing plate 10 of the battery cell 1, and the second duct 6B is disposed between the first duct 6A and the battery stacked member 2. In the gas duct 6, the first duct 6A and the second duct 6B are coupled to each other, and then the tubular shape of the gas passage 46 is formed. The first duct 6A has a groove portion 6d having a groove shape as a recess, and an opening portion of this groove portion 6d is disposed in a posture of facing the gas exhaust opening 12 of the battery cell 1. In the first duct 6A, the metal layer 17 is provided on the upper surface 6t of the gas passage 46 of the inner surface of the groove portion 6d. Further, the first duct 6A shown in FIG. 6 has a flange portion 6a integrally molded projecting outward along the opening edge of the groove portion 6d in order to be fixed to the battery stacked member 2 through the second binding member 5 mentioned below.

The second duct 6B has a board shape which is disposed along the first surface 2A of the battery stacked member 2, and has a recess 6c formed by step into which the flange portion 6a is press-fitted on the top surface thereof. The flange portion 6a of the first duct 6A is press-fitted into the recess 6c of the first duct 6B, and by this, the first duct 6A and the second duct 6B are coupled, and then the hollow shape of the gas duct 6 is formed. The first duct 6A and the second duct 6B are airtightly fixed by vibration welding, by ultrasonic-welding, or by gluing. Here, the first duct and the second duct do not necessarily need to be fixed by welding, or by gluing, and a gasket (not shown in the figures) at the boundary between the recess and the flange is disposed, and the gasket is sandwiched and fixed, and then the first duct and the second duct can be airtightly coupled.

Further, the second duct 6B has the joining apertures 6b coupled to the gas exhaust opening 12 of each of the battery cells 1, and the joining apertures 6b are coupled to the gas exhaust openings 12. The second duct 6B of FIG. 6 has the rectangular joining apertures 6b opened at a position facing to the gas exhaust openings 12 of the battery cells 1. Here, the joining aperture can have an elongated circle, track, or elliptic shape along the gas exhaust opening of the battery cell.

As mentioned above, in the structure in which the gas duct 6 is divided into the first duct 6A and the second duct 6B, the first duct 6A and the second duct 6b can be made of different plastic materials. In this gas duct 6, the first duct 6a can be made of plastic having excellent heat-resistance property, the second duct 6B can be made of plastic having excellent insulating property. The first duct 6a can be made of polybutylene terephthalate, or plastic, for example, nylon resin, epoxy resin, or the like reinforced by containing glass fiber, carbon fiber, or the like. The second duct 6B can be made of insulating plastic, for example, nylon resin, epoxy resin, or the like. In the second duct 2B made of insulating plastic, even though the second duct contacts the surface of the battery cell, there is no short circuit in the outer cans of battery cells.

### (Bus Bar Holder)

In the power supply device shown in FIG. 6, FIG. 7, and FIG. 9, a bus bar holder 8 is disposed on the first surface 2A of the battery stacked member 2, and the bus bar holder 8 covers the sealing plates 10 of the battery cells 1. The bus bar holder 8 is molded in an outer shape along the upper surface of the battery stacked member 2. Here, in the power supply device shown in the figures, the bus bar holder 8 is used also as the second duct 6B. Namely, in the bus bar holder 8 shown in the figures, the portion facing to the plural gas exhaust openings 12 disposed at the center of the battery stacked member 2 is used also as the second duct 6B having the plural joining apertures 6b. Therefore, the bus bar holder 8 is made of insulating plastic, for example, nylon resin, epoxy resin, or the like.

Further, as shown in FIG. 6 and FIG. 9, the bus bar binder 8 has opening windows 24 opened in which the bus bars 14 are disposed at the positions facing to the electrode terminals 13 of the battery cells 1. In the bus bar holder 8 of the figures, the plural opening windows 24 are formed at both sides of the center portion constituting the second duct 6B, along both side portions of the battery stacked member 2. The opening windows 24 have a size of the outer shape of the bus bar 14 so as to guide the bus bar 14 into the fixed positions and connect the electrode terminals 13. The bus bars 14 disposed into the opening windows 24 of the bus bar holder 8, are fixed to the electrode terminals 13 by laser welding or the like, and the plural battery cells 1 are connected in a state of a predetermined connection. Here, in the power supply device, the bus bar holder does not necessarily need to be disposed on the first surface of the battery stacked member. The above bus bar holder 8 is fixed to the first surface of the battery stacked member 1 through the second connecting member 5 which couples the gas duct 6 to the battery stacked member 2.

As mentioned above, the bus bar holder 8 disposed on the first surface 2A of the battery stacked member 2, is used also as the gas duct 6, and by this, the number of component parts is reduced, and then the gas duct 6 can be simply and at low cost disposed.

Further, in the structure in which the bus bar holder 8 is used also as the gas duct 6, as the first duct 6A can be coupled in a state that the battery stacked device 2 is bound in advance through the binding member 4 at the process of assembling the power supply device, the first duct 6A can be more surely airtightly coupled to the second duct 6B. Here, in the power supply device of the present embodiment, the gas duct as a separate part can be disposed on the first surface of the battery stacked member without the bus bar holder used as the gas duct.

### (Second Binding Member 5)

The above gas duct 6 is disposed, facing to the gas exhaust openings 12 of the battery stacked member 2, and is fixed at the fixed position through the second binding member 5 disposed on the first surface 2A of the battery stacked member 2. As shown in FIG. 9, the second binding member 5 is disposed, facing to the first surface 2A of the battery stacked member 2, and disposes the gas dust 6 at the fixed position. Both ends of the second binding member 5 are also fixed to the end plates 3, and the battery stacked member 2 is bound on the first surface. The second binding member 5 is a metal board having predetermined width and thickness, and is made of a metal board of iron, preferably a steel board. The second binding member 5 made of metal board has connecting portions 5B at both ends of a binding portion 5A, and the connecting portions 5B is coupled to the outer surfaces of the end plates 3.

The second binding member 5 shown in the figures comprises two rows of the binding portions 5A, and the connecting portions 5B connecting both ends of the binding portions 5A. The two rows of the binding portions 5A are disposed along both sides of the gas duct 6. The two rows of the binding portions 5A are disposed at a predetermined space so as to press the flange portion 6a of both sides of the gas duct. The second binding member 5 is fixed to the end plates 3 in a state that the gas duct 6 is disposed between the two rows of the binding portions 5A, and the two rows of the binding portions 5A press the flange portion 6a. Both ends of the two rows of the binding portions 5A are connected by the connecting portions 5B, and the connecting portions 5B are bent at approximately right angle, and are coupled to the end plates 3. The connecting portions 5B at both ends of the second binding member 5 are coupled to the press fit recesses 3B formed in the end plates 3, and by a pair of the end plates 3 having a predetermined space, the battery stacked member 2 is sandwiched and fixed form both sides. Further, both end portions of the second binding member 5 are fixed to the end plates 3 by the screws 19. Both end portions of the binding portions 5A of the second binding member 5 of the figures have through holes opened into which the screws 19 are inserted. In the second binding member 5, the screws 19 are inserted into the through holes in a state that the connecting portions 5B of both ends are coupled to the press fit recesses 3B of the end plates 3, and the screws 19 are screwed into the screw holes 3b of the outer surface of the end plates 3, and then the second binding member 5 is fixed to a pair of the end plates 3.

In the second binding member 5 shown in the figures, the two rows of the binding portions 5A and the connecting portions at both ends thereof are integrally made. However, the second binding member can be divided into two rows of parts. In the second binding member divided into two rows of parts, not shown in the figures, each of the two rows of the parts is disposed along both sides of the gas duct, and the flange portions projecting from both sides of the gas duct can be pressed by each of the binding portions thereof.

Further, in the second binding member, not shown in the figures, the two rows of the binding portion are coupled by a bridge portion therebetween in the middle thereof, and the bridge portion can be disposed on the upper surface of the gas duct. In the second binding member, the bridge portion pressed the upper surface of the gas duct, and the gas duct can be disposed in a fixed position on the first surface of the battery stacked member. Further, the second binding member, not shown in the figures, has one row of the binding portion, the one row of the binding portion presses the upper surface of the gas duct, and the gas duct can be disposed at a fixed position on the first surface of the battery stacked member.

### (Electrical Circuit Board)

Further, the power supply device shown in FIG. 6 and FIG. 9 has an electrical circuit 9 connected to the battery stacked member 2, and the circuit board 9 is disposed between the gas duct 6 and a top cover 20. The circuit board 9 includes electrical parts (not shown in the figures) which realize a protection circuit of the battery cells 1, or the like. The circuit board 9 includes a voltage detecting circuit which is connected to each of the battery cells 1 and detects cell voltages, a temperature detecting circuit which detects temperature of the battery cell 1, or the like, and controls so as to prevent over charge or over discharge by detecting the cell voltages, and controls charging and discharging an abnormal temperature increase of the battery cell 1. The electrical parts which realize these circuits are disposed on or in the circuit boards 9, and are stored in a storage recess portion 21.

The circuit board 9 shown in the figures is disposed at a fixed position on the upper surface of the gas duct 6 through the second binding member 5. The second binding member 5 shown in FIG. 6, FIG. 7, and FIG. 9 has plural nuts 25 which are fixed on the upper surface of the binding portion 5A in order to fix the circuit board 9. In the power supply device of the figures, bolts 26 which penetrate the circuit board 9 are screwed into the nuts 25, and the circuit board 9 is disposed at the fixed position on the upper surface of the gas duct 6. In the power supply device, as the second binding member 5 made of the metal board is disposed between the circuit board 9 and the battery stacked member 2, the circuit board 9 can be shielded from the battery stacked member 2. Further, in the power supply device, as the metal layer 17 is provided on the inner surface of the gas duct 6, the circuit board 9 can be shield by the metal layer 17. As the battery stacked member 2 is charged or discharged by large current, especially by large pulse current, noises of the pulses are emitted. The metal board of the second binding member 5 and the metal layer 17 of the gas duct 6 are located between the circuit board 9 and the battery stacked member 2, and the circuit board 9 can be shielded from the induced noises by pulses emitted from the battery stacked member 2, and then an erroneous operation of the circuit board by the induced noises can be prevented. Especially, the second binding member of the metal board is connected to an earth line, and then the induced noises from the battery stacked member 2 can be more effectively shielded.

### (Top Cover)

Further, the power supply device of FIG. 6 and FIG. 7 disposes the top cover 20 on the top surface thereof. The top cover 20 covers the upper surface of the bus bar holder 8, and covers and protects the bus bar 14 or the circuit board 9. Therefore, the top cover 20 has an outer shape which can cover the upper surface of the bus bar holder 8, and the outer shape of the top cover 20 has a space which stores the circuit board 9, and is molded using plastic material. The top cover 20 shown in FIG. 6 is molded in the outer shape of a shallow container having an opening at the lower side, and the center portion is made deep by a step compared with the periphery, and then the storage recess portion 21 to store the circuit board 9 is provided.

Further, one end portion of the top cover 20 as shown in FIG. 5 has a cutout 22 through which the duct exhaust portion 6x projects outside. In a state that the top cover 20 is coupled to the upper surface of the battery stacked member 2 as shown in FIG. 5, the duct exhaust portion 6x projects outside through the cutout 22. Furthermore, the top cover 20 as shown in FIG. 5 has output terminal windows 23 at both end portions thereof. In the battery stacked member 2, output terminal boards 16 are connected to the electrode terminals 13 of the battery cells 1 disposed at both ends thereof. The top cover has the output terminal windows 23 opened through which the output terminal boards 16 are exposed outside.

The above top cover 20 is fixed to the gas duct 6 by bolts 27. The gas duct 6 shown in FIG. 9 is integrally molded with connecting bosses 28 on the upper surface thereof to fix the top cover 20 at the fixed position. The connecting bosses 28 of FIG. 9 project from the upper surface at both end portions thereof. The top cover 20 defines the through holes 29 at a position facing to the connecting bosses 28, and the bolts 27 which penetrate the through holes 29 are screwed into the connecting bosses 28 of the gas duct 6, and then the top cover 20 is fixed at the fixed position of the battery stacked member 2. The power supply device having the top cover 20 prevents that connecting portions of high voltage between the battery cells 1, the circuit board, or the like is exposed. For example, it is prevented that connecting portions between the battery cells 1, the circuit board, or the like is carelessly contacted, and the circuit is short-circuited at the time of maintenance. Further, effect of water proof is easily obtained.

The power supply device of the above embodiment, the gas duct 6 is fixed to the first surface 2A of the battery stacked member 2 through the second binding member 5. However, the gas duct does not necessarily need to be fixed to the battery stacked member through the second binding member, and can be fixed to the battery stacked member through other connecting structure.

Regarding cooling of the power supply device, for example, a cooling plate is disposed to the bottom surface of the battery stacked member, the cooling plate transfers heat. Coolant is circulated inside the cooling plate, and the cooling plate is forcibly cooled, and cooling is efficiently carried out by heat exchange. In place of the cooling plate, for example, as the power supply device for vehicle, the battery stacked member is fixed to chassis of vehicle, and by heat exchange to the chassis, heat is naturally radiated. The fixed position does not necessarily need to be the bottom surface of the battery stacked member, and can be other surfaces of the side surface or the like. Furthermore, the battery cell can be cooled by blowing cooled air. For example, the spacer disposed between the battery cells has a cooling space where the cooled air flows, and by forcibly blowing cooled air to the cooling space the battery cells can be effectively cooled.

The aforementioned power supply devices can be used as a power supply for vehicles. The power supply device can be installed on electric vehicles such as hybrid cars that are driven by both an internal-combustion engine and an electric motor, and electric vehicles that are driven only by an electric motor. The power supply device can be used as a power supply device for these types of vehicles.

### (Hybrid Car Power Supply Device)

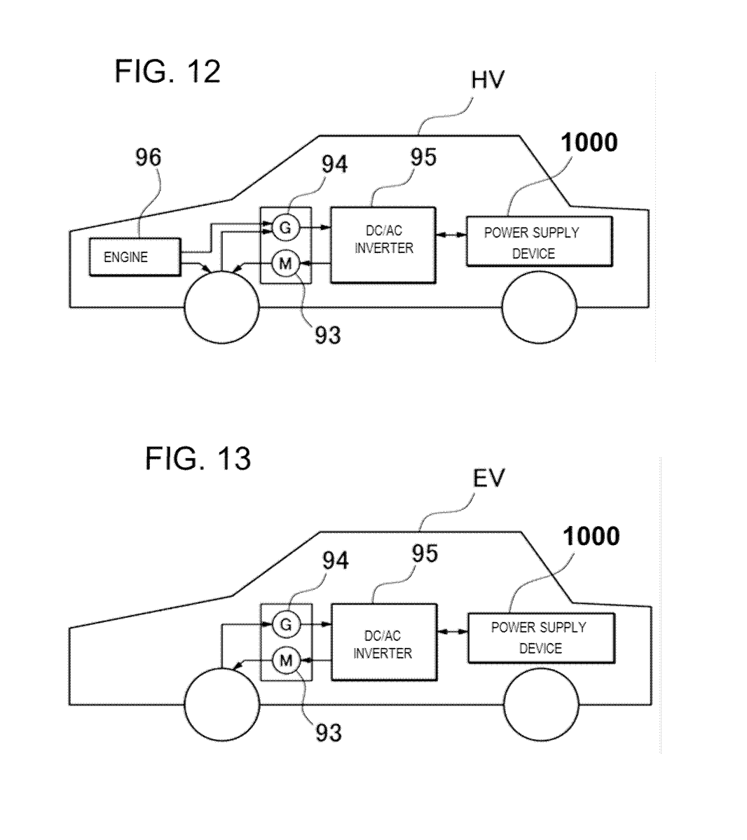

FIG. 12 is a block diagram showing an exemplary hybrid car that is driven both by an engine and an electric motor, and includes the power supply device. The illustrated vehicle HV with the power supply device includes an electric motor 93 and an internal-combustion engine 96 that drive the vehicle HV, a power supply device 1000 that supplies electric power to the electric motor 93, and an electric generator 94 that charges batteries of the power supply device 1000. The power supply device 1000 is connected to the electric motor 93 and the electric generator 94 via a DC/AC inverter 95. The vehicle HV is driven both by the electric motor 93 and the internal-combustion engine 96 with the batteries of the power supply device 1000 being charged/discharged. The electric motor 93 is energized with electric power and drives the vehicle in a poor engine efficiency range, e.g., in acceleration or in a low speed range. The electric motor 93 is energized by electric power that is supplied from the power supply device 1000. The electric generator 94 is driven by the engine 96 or by regenerative braking when users brake the vehicle so that the batteries of the power supply device 1000 are charged.

### (Electric Vehicle Power Supply Device)

FIG. 13 shows an exemplary electric vehicle that is driven only by an electric motor, and includes the power supply device. The illustrated vehicle EV with the power supply device includes the electric motor 93, which drives the vehicle EV, the power supply device 1000, which supplies electric power to the electric motor 93, and the electric generator 94, which charges batteries of the power supply device 1000. The electric motor 93 is energized by electric power that is supplied from the power supply device 1000. The electric generator 94 can be driven by vehicle EV regenerative braking so that the batteries of the power supply device 1000 are charged.

### (Power Storage Type Power Supply Device)

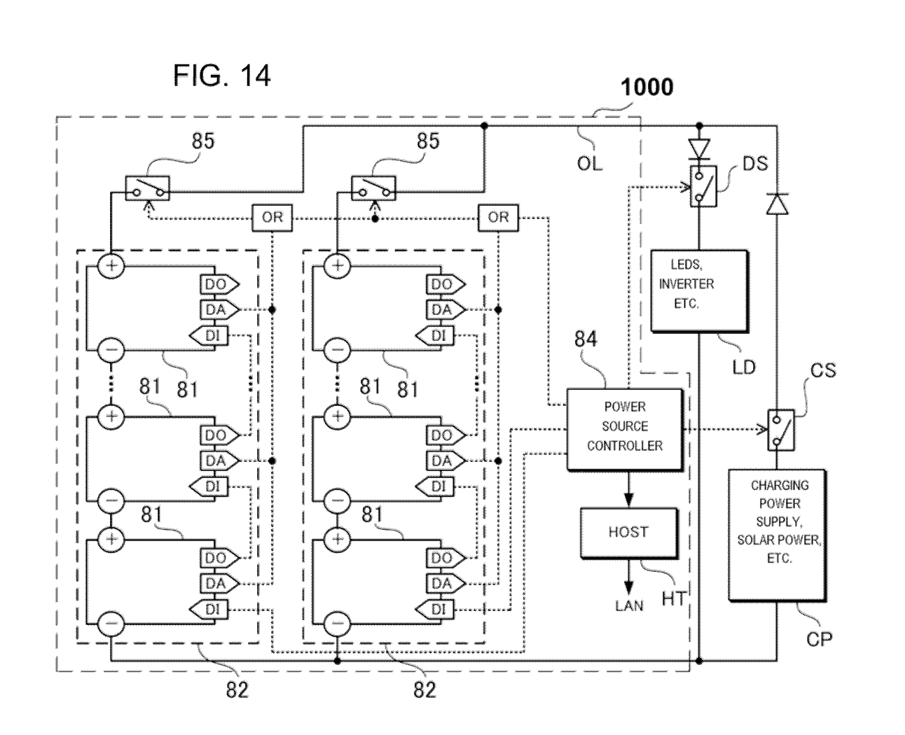

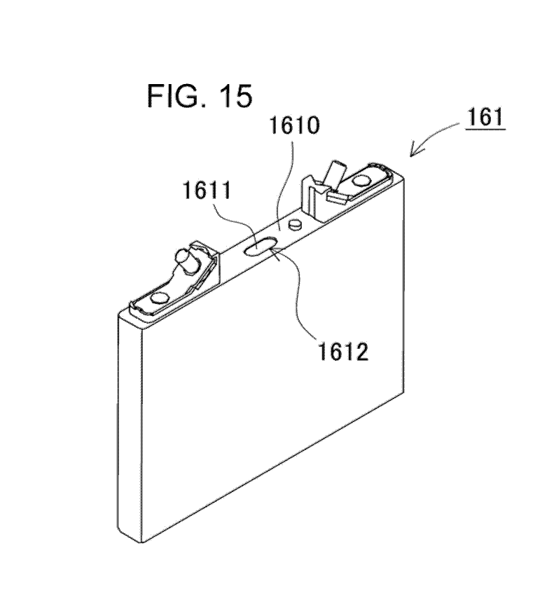

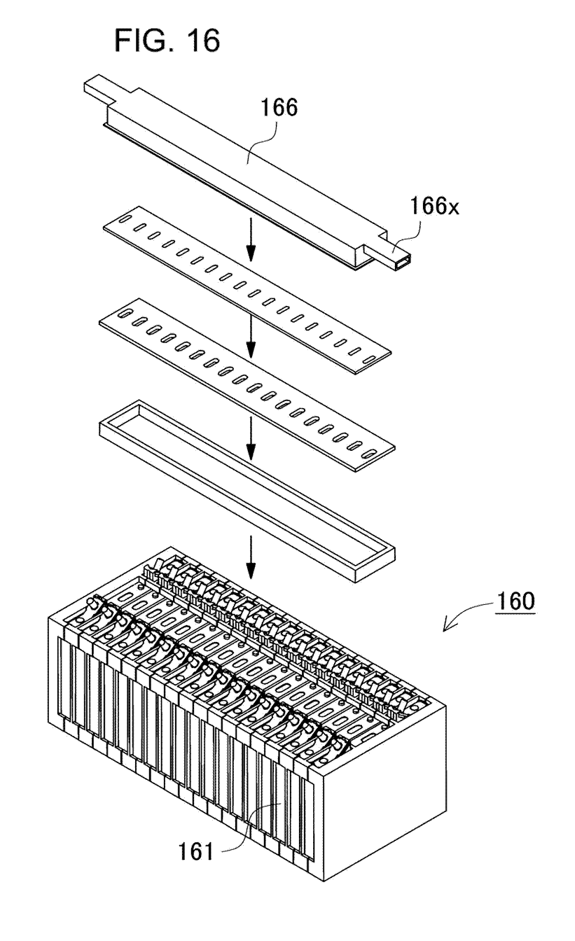

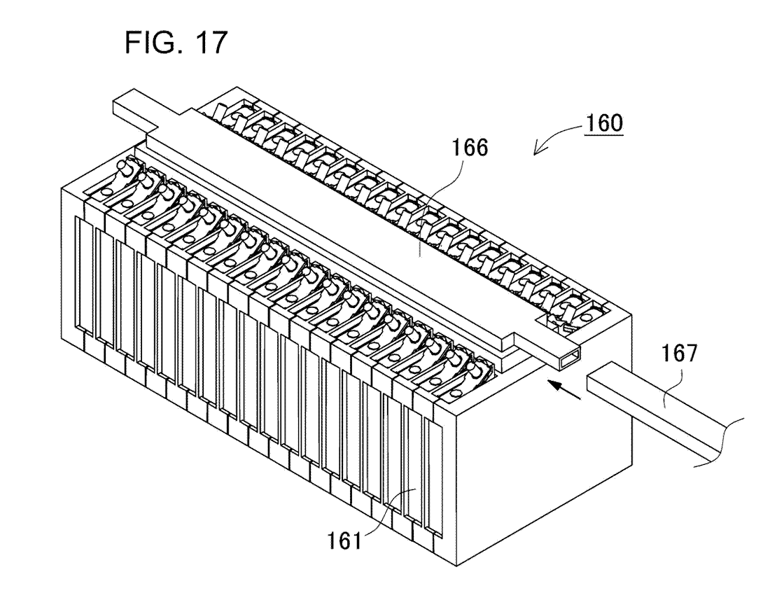

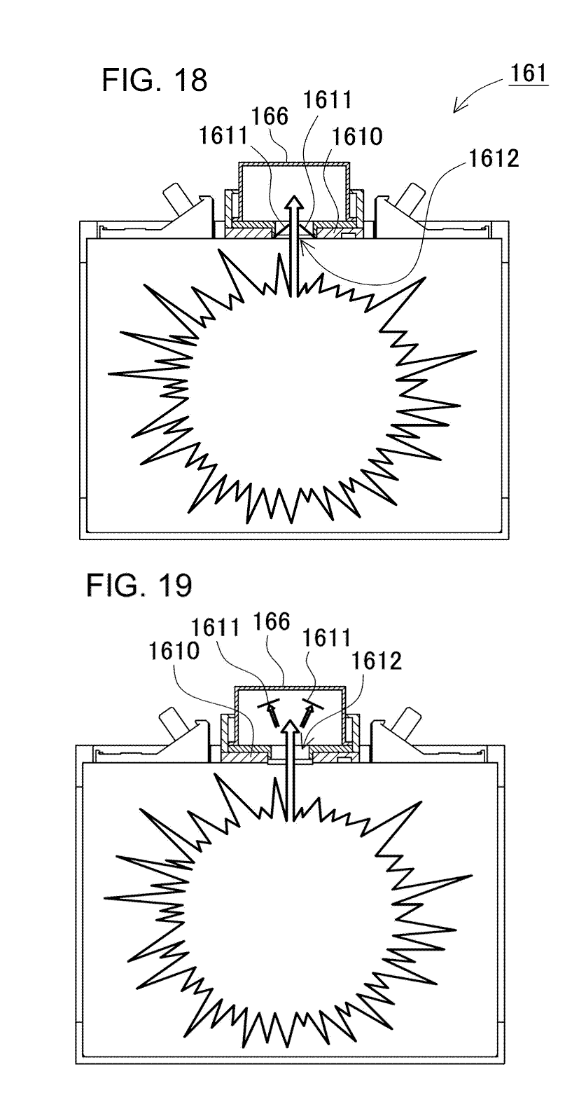

The power supply device can be used not only as power supply of mobile unit but also as stationary power storage. For example, examples of stationary power storage devices can be provided by an electric power system for home use or plant use that is charged with sunlight or with midnight electric power and is discharged when necessary, a power supply for street lights that is charged with sunlight during the daytime and is discharged during the nighttime, or a backup power supply for signal lights that drives signal lights in the event of a power failure. FIG. 14 shows an exemplary circuit diagram. This illustrated power supply device 1000 includes battery units 82 each of which includes a plurality of battery packs 81 that are connected to each other. In each of battery packs 81, a plurality of rectangular battery cells 1 are connected to each other in serial and/or in parallel. The battery packs 81 are controlled by a power supply controller 84. In this power supply device 1000, after the battery units 82 are charged by a charging power supply CP, the power supply device 1000 drives a load LD. The power supply device 1000 has a charging mode and a discharging mode. The Load LD and the charging power supply CP are connected to the power supply device 1000 through a discharging switch DS and a charging switch CS, respectively. The discharging switch DS and the charging operation switch CS are turned ON/OFF by the power supply controller 84 of the power supply device 1000. In the charging mode, the power supply controller 84 turns the charging operation switch CS ON, and turns the discharging switch DS OFF so that the power supply device 1000 can be charged by the charging power supply CP. When the charging operation is completed so that the battery units are fully charged or when the battery units are charged to a capacity not lower than a predetermined value, if the load LD requests electric power, the power supply controller 84 turns the charging operation switch CS OFF, and turns the discharging switch DS ON. Thus, operation is switched from the charging mode to the discharging mode so that the power supply device 1000 can be discharged to supply power to the load LD. In addition, if necessary, the charging operation switch CS may be turned ON, while the discharging switch DS may be turned ON so that the load LD can be supplied with electric power while the power supply device 1000 can be charged.

The load LD driven by the power supply device 1000 is connected to the power supply device 1000 through the discharging switch DS. In the discharging mode of the power supply device 1000, the power supply controller 84 turns the discharging switch DS ON so that the power supply device 1000 is connected to the load LO. Thus, the load LD is driven with electric power from the power supply device 1000. Switching elements such as FET can be used as the discharging switch DS. The discharging switch DS is turned ON/OFF by the power supply controller 84 of the power supply device 1000. The power supply controller 84 includes a communication interface for communicating with an external device. In the exemplary power supply device shown in FIG. 14, the power supply controller is connected to a host device HT based on existing communications protocols such as UART and RS-232C. Also, the power supply device may include a user interface that allows users to operate the electric power system if necessary.

Each of the battery packs 81 includes signal terminals and power supply terminals. The signal terminals include a pack input/output terminal DI, a pack abnormality output terminal DA, and a pack connection terminal DO. The pack input/output terminal DI serves as a terminal for providing/receiving signals to/from other battery packs and the power supply controller 84. The pack connection terminal DO serves as a terminal for providing/receiving signals to/from other battery packs as slave packs. The pack abnormality output terminal DA serves as a terminal for providing an abnormality signal of the battery pack to the outside. Also, the power supply terminal is a terminal for connecting one of the battery packs 81 to another battery pack in series or in parallel. In addition, the battery units 82 are connected to an output line OL through parallel connection switches 85, and are connected in parallel to each other.

### INDUSTRIAL APPLICABILITY

A power supply device according to the present invention can be suitably used as power supply devices of plug-in hybrid vehicles and hybrid electric vehicles that can switch between the EV drive mode and the HEV drive mode, electric vehicles, and the like. A vehicle including this power supply device according to the present invention can be suitably used as plug-in hybrid vehicles, hybrid electric vehicles, electric vehicles, and the like. Also, a power supply device according to the present invention can be suitably used as backup power supply devices that can be installed on a rack of a computer server, backup power supply devices for wireless communication base stations, electric power storages for home use or plant use, electric power storage devices such as electric power storages for street lights connected to solar cells, backup power supplies for signal lights, and the like.

1. A power supply device comprising:
a battery cell comprising:
an outer can; and
a gas exhaust valve opening a part of the outer can in response to becoming a high pressure in the inside of the outer can,
a gas duct guiding the gas exhausted from the gas exhaust valve to an external gas exhaust duct,
wherein the gas exhaust valve is integrally coupled to the outer can at the time of opening the gas exhaust valve, and the connecting portion between the outer can and the gas exhaust valve is partially broken at the time of opening the gas exhaust valve by an internal pressure of the outer can,
the gas duct further comprising:
a joining aperture being connected airtight to the gas exhaust valve; and
a duct exhaust portion being connected to the external gas exhaust duct,
wherein the inner diameter inside the gas duct is at least partially smaller than the outer diameter of the gas exhaust valve between the joining aperture and the duct exhaust portion.

2. The power supply device according to claim 1, wherein the duct exhaust portion is smaller than the outer diameter of the gas exhaust valve.

3. The power supply device according to claim 1, wherein the gas exhaust valve is made of a metal board.

4. The power supply device according to claim 1, wherein the outer can has a tubular shape of a rectangle in a sectional view having a bottom portion, and an opening at the top portion, and the opening of the outer can is closed by a sealing plate made of metal, and the gas exhaust valve is the metal board which is made as a thin portion in a part of the sealing plate, and the gas exhaust valve opens by the metal board being broken from the sealing plate at the time of increasing the internal pressure of the outer can.

5. The power supply device according to claim 4,
wherein in the sealing plate, an elongated hole is formed in a state of the gas exhaust valve opening,
the gas exhaust valve is formed as the thin portion in the sealing plate at the center in the elongated direction in a state of the gas exhaust opening being closed, and
in response to becoming a high pressure in the inside of the outer can, the center of the gas exhaust valve is broken, and the gas exhaust valve opens toward outside the outer can.

6. The power supply device according to claim 4,
wherein the plural battery cells in a state of being stacked are bound by a binding member in a posture that the sealing plates are trued up, and
the gas duct is extended in the stacked direction of the battery cells, and the gas duct is fixed such that the gas duct faces each of the gas exhaust valves of a battery stacked member bound by the binding member of the battery cells.

7. A vehicle equipped with the power supply device according to claim 1, comprising:
an electric motor being energized by electric power that is supplied from the power supply device;
a vehicle body having the power supply device and the electric motor; and
a wheel being driven by the electric motor, and driving the vehicle body.

8. A storage battery device equipped with the power supply device according to claim 1, comprising:
a power supply controller controlling charging and discharging of the power supply device,
wherein the power supply device is charged with an external power by the power supply controller, and charging of the power supply device is controlled by the power supply controller.
